(19) United States
(12) Patent Application Publication
(10) Pub. No.: US 2015/0336222 A1
(43) Pub. Date: Nov. 26, 2015

(54) METHOD AND DEVICE FOR MOUNTING AND REMOVING OF A TURBINE COMPONENT

(71) Applicant: ALSTOM Technology Ltd, Baden (CH)

(72) Inventors: Davide ARATORI, Nussbaumen (CH); Damir Golubic, Karlovac (HR); Daniel Seng, Busslingen (CH); Marc Rauch, Frenkendorf (CH)

(21) Appl. No.: 14/715,994

(22) Filed: May 19, 2015

(30) Foreign Application Priority Data
May 26, 2014 (EP) 14169844.9

(51) Int. Cl. B23P 6/00; F23R 3/00

(52) U.S. Cl. CPC B23P 6/002; F23R 3/002

(57) ABSTRACT

The disclosure pertains to a mounting system for mounting and/or removing a turbine component from a turbine. The mounting system includes a suspended rail structure for moving the turbine component with a traveller which movably connects a holder for holding the turbine component to the rail structure. It further includes a lifter with a support frame which is attachable to the lifter and configured for receiving the turbine component with the holder. The disclosure further refers to a method for mounting and removing a turbine component.

### CROSS-REFERENCE TO RELATED APPLICATIONS

This application claims priority to European application 14169844.9 filed May 26, 2014, the contents of which are hereby incorporated in its entirety.

### TECHNICAL FIELD

The present invention relates to a replacing system for large parts or components of a turbine. It is applied for removing or mounting turbine components to inspect, repair or replace them. Further, it relates to a method for removing or mounting turbine components.

### BACKGROUND

Turbine part or components need to be removed for inspection, maintenance and repairs or replacement of the parts or components. Such components can for example be burners of a gas turbine for thermal power generation. Burners are typically arranged radially at equal intervals at the middle part of the main body of the gas turbine and are inserted and assembled via flanges thereto. Conventionally, such parts are replaced manually by constructing simple scaffolds after removing pipes and other obstacles around the part and by manipulating an overhead traveling crane to sling the part by workers who get on the scaffolds.

Parts or components such as burners can be far too heavy to be handled by workers without the use of cranes or other lifting tools. Such a removal and handling is time consuming and it is difficult to maintain an adequate position of the burner during the works in the narrow inner space of the turbine and on the unstable outside scaffolds.

In order to make this work easier, U.S. Pat. No. 5,921,075 discloses a burner replacement system in which a rail is attached at a circumferential flange connection of two axially adjacent parts of the gas turbine housing, wherein a carriage of complex design can be moved along this rail in order to transport the burner to be installed. The carriage is equipped with an articulation and with a burner carrier which can be displaced in translation such that it can transport individual burners of the gas turbine to their intended location. A disadvantage of the known device is, however, that it is very large and requires a comparatively large maneuvering space around the turbine housing. However, this maneuvering space is not always available. A further disadvantage of the known device is that, on account of the comparatively long and free-ending rod assembly on the carriage, and the considerable weights of the components to be replaced, such as burners and transition pipes, these can only be positioned with insufficient precision with respect to the component opening through which they are to be introduced into the turbine.

### SUMMARY

The object of the present disclosure is to provide a mounting system for installing and removing a component on or in a turbine, which mounting system, on one hand, is compact and, on the other hand, allows exact-fit positioning of the relevant component on or in the turbine. It is a further object of the disclosure to provide a method for mounting and removing a part or component of a turbine, which method can be carried out quickly without a particularly large installation space requirement.

According to a first embodiment a mounting system for mounting and removing a turbine component comprises a suspended rail structure for moving the turbine component with a traveller which can move along a rail of the rail structure and can be connected to a holder for attaching the turbine component to the traveller. It further comprises a lifter and a support frame. The support frame is attachable to the lifter and configured for receiving the turbine component with the holder from the traveller.

The rail structure can for example be attachable to a turbine or turbine housing. The mounting system can be a system for mounting a turbine component to a turbine. In particular it can be a system for mounting a combustor component such as a burner or liner to, respectively into a combustor casing.

The lifter can be any commercially available lifting equipment such as a fork lift with a sufficient loading capacity. The support frame can be form fit to lifter, e.g. to the fork of a fork lifter. The support frame can further be formed to receive the turbine component in a form fit connection. A lifter can also be a movable service platform, guided mobile lifting table or another lifting carriage.

The lifter can be a lifter for vertical lifting, for example from the floor of the power plant.

According to another embodiment the mounting system comprises a guide rail for guiding the lifter along a predefined path to the correct position for lifting or receiving the turbine part. The rails can be fixed to the ground. Instead of rails marks indicating the correct position of the lifter on the ground can also be used. A positioning device such as a master plate can be used to place the rails in the correct position relative to a fix point of the turbine such as the bearing or king pin. Also an optical guidance or any other precise position system can be used. Precise positioning in this context means a positioning within a few centimeters tolerance, preferably with a tolerance of less than 1 cm, more preferably within less than half a centimeter.

According to a further embodiment the holder comprises a metal belt which is form fit to a first section of the turbine component. The metal belt can be buckled on the turbine component for holding or lifting the turbine component.

According to yet another embodiment the holder comprises a bracket which is configured for connection to a second section of the turbine component. The turbine component can be attached to the traveller with the help of a metal belt or of a bracket or a combination of both.

The suspended rail structure of the mounting system that can for example comprise a beam and in the traveller can comprise a trolley and/or a linear guide connected to the beam.

For pushing and pulling the traveller along the rail structure the mounting system can comprise a jacking screw system. According to a further embodiment the jacking screw system is a self-breaking system.

According to an embodiment the one end of the rail structure is mounted to a bracket with a joint, and connected to at least one further bracket via a tie rod or a chain spanning from the brackets to the rail structure for a hinged suspension.

The joint connecting the end of the rail structure to the bracket allows an adjustment of the tilt angle of the rail structure by adjusting the length of the tie rod, the chain or the rod chain combination.

The tilt angle can for example be the angle relative to the horizontal plane, relative to the axis of the turbine, or the axis of a turbine component. For an adjustment the reference can typically be freely chosen, as long as it is a fixed reference plane.

In another embodiment two or more tie rods span from a bracket or support point to the rail structure and hold the beam in a defined angle relative to the turbine. The tilt angle of the beam can be adjusted by adjusting the length of the tie rods. The use of multiple tie rods allows the design of a lighter rail system as the rod is supported at many points and bending moments acting on the rail system can be reduced.

According to a further embodiment the mounting system comprises a traveller with a first section for movable connection to the rail structure, a second section for connection to the holder, and an interface connecting the first section to the second section. The interface is configured for adjusting the position of the second section relative to the first section for aligning the position of the turbine component suspended by the mounting system relative to the turbine.

For alignment the adjustable interface can for example comprise two screws: One for horizontal and one for vertical displacements of the first section relative to the second section. The fine tuning can for example be done in a plane normal to the axial extension of the beam of the rail structure.

The mounting system can further comprise a tool frame which is attachable to the lifter and which is configured for receiving the rail structure with the traveller. With the help of the tool frame the rail structure together with the traveller can be mounted/dismounted to a turbine. For mounting/dismounting the frame tool has to be attached to the lifter. The rail structure with traveller has to be attached to the frame tool for mounting and the lifter can be driven to a defined position below or next to the turbine. The lifter then lifts the rail structure with traveller up to the turbine for mounting to the turbine. Once the rail structure with traveller is mounted on the turbine the lifter with tool frame can be removed and the tool frame can be replaced by the support frame. Dismounting of the rail structure with traveller can be done analogously with a reverse order of the steps.

For correct placement of the lifter rails or any other precise position system can be used can be used to guide the lifter.

According to a further embodiment the mounting system comprises at least one of a manual handle, an electro motor, and a pneumatic motor for moving the traveller relative to the rail structure. A controlled movement of the traveller is important to assure a safe handling of the turbine component which is removed or mounted with the mounting system.

Besides the mounting system a method for mounting, respectively a method for removing a turbine component from a turbine is an object of the disclosure.

The method for mounting, respectively removing a turbine component from a turbine comprises the step of providing a mounting system for a turbine component. Such a mounting system has a suspended rail structure for moving the turbine component with a traveller which can move along a rail of the rail structure and can be connected to a holder for attaching the turbine component to the traveller. It further comprises a lifter with a support frame which is attachable to the lifter and configured for receiving the turbine component with the holder from the traveller. The mounting system can further comprise a fixing bracket for suspension of the rail structure from the turbine.

According to the method the rail structure with the traveller can be mounted to the turbine a tie rod and/or a chain and pivotably connected to the turbine. For connection to the turbine brackets can be used. After mounting the rail structure it can be aligned with the turbine component, respectively the turbine into which the component is to be introduced, by adjusting the length of the tie rod or chain which are used to connect the rail structure to the turbine.

For removing a turbine component the axial extension of the rail structure can for example be aligned to the axis of the installed turbine component which is to be removed.

For mounting a turbine component axial extension of the rail structure can for example be aligned to the axis of the opening in the turbine into which the turbine component is to be mounted.

According to a first embodiment of the method for removing a turbine component the turbine component can now be attached to the traveller which is moved along the rail to a dismounting position above the turbine component with the help of a holder. Once attached to the traveller the turbine component can be pulled out of the turbine by moving the traveller along the rail structure. In a next step the lifter with the support frame attached to it can be moved to a defined position below the turbine component, and the support frame can be lifted by the lifter to receive the turbine component. Once the support frame is in place, holding the turbine component, the turbine component, respectively the holder, can be, detached from the traveller and the turbine component can be removed with the lifter which is holding the support frame and turbine component.

The method for mounting a turbine component includes the steps of providing a mounting system and aligning the mounting system with the turbine as described above.

In addition such a method for mounting a turbine component comprises the steps of moving the turbine component with the lifter which is holding the support frame and turbine component to a defined position below the rail structure, lifting the support frame with the turbine component up to the traveller and connecting the holder with the turbine component to the traveller. Once the turbine component is connected to the traveller the support frame can be lowered with the lifter and the turbine component can be pushed to the turbine by moving the traveller along the rail structure to a mounting position (typically this position is identical to the dismounting position). In the mounting position the turbine component can be attached to the turbine for example with the help of bolts fixing the part to a flange of the turbine casing.

According to a further embodiment of the method for removing a turbine component from a turbine, respectively of the method for mounting of a turbine component the methods comprise the steps of attaching tool frame to the lifter, and attaching the rail structure with the traveller to the tool frame. Once the rail structure is attached, the lifter can be moved to a defined position next to or below the turbine and the lifter can lift the rail structure with the traveller for mounting to the turbine.

Once lifted to the correct position the rail structure with the traveller can be mounted to the turbine with tie rods or chains. For connection to the turbine brackets can be used.

### BRIEF DESCRIPTION OF THE DRAWINGS

The disclosure, its nature as well as its advantages, shall be described in more detail below with the aid of the accompanying schematic drawings. Referring to the drawings:

FIG. 1 shows a cut out of a turbine with a turbine component in the installed position and the turbine component indicated in a pulled position,

FIG. 2 shows a perspective view of an exemplary mounting system;

FIG. 3 shows a side wall mounted rail structure;

FIG. 4 shows a top mounted rail structure;

FIG. 5 shows an example the rail structure with traveller and holder;

FIG. 6 shows an example of a lifter with a tool frame and rail structure;

FIG. 7 shows an example of a traveller and holder for a turbine component;

FIG. 8, 8a, 8b, 8c shows details of a traveller with a first and a second section whose position can be adjusted relative to one another.

### DETAILED DESCRIPTION

A typical mounting position for a turbine component 7 in turbine 30 is shown in FIG. 1. The turbine component 7 of this example is a combustor which is installed in a turbine 30. For service or replacement the combustor has to be pulled out of the by a displacement 27 thereby bringing the turbine component 7 in the position indicated by the dotted lines. Once the turbine component 7 is pulled to an outside position it can be removed from the turbine without interfering with the turbine casing or other parts which could hinder its movement.

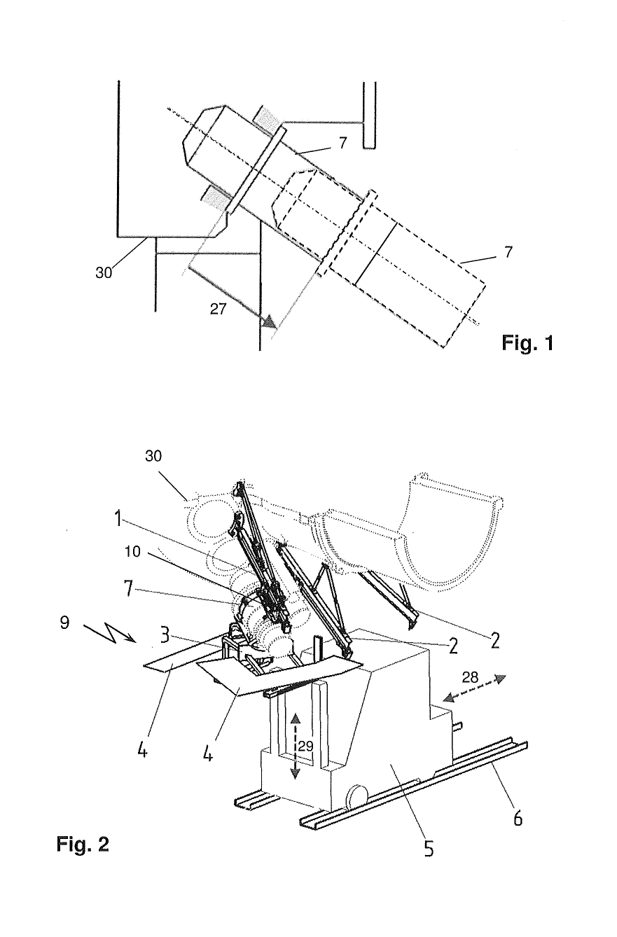

In particular on the lower half of the turbine 30 which is not directly accessible by overhead cranes the removal of heavy turbine components 7 from the turbine 30 is difficult. The mounting system 9 comprises a rail structure 1 which can be attached to a turbine 30. In the example of FIG. 2 the rail structure comprises a monorail 2 to which the turbine component 7 (in this example a combustor) can be movably attached with the help of a traveller 10. The turbine component 7 can be removed (pulled) from the turbine 30 or mounted to the turbine 30 along the linear extension of the rail structure 1. After moving the turbine component 7 out of the turbine along the rail structure 1 the turbine component 7 can be received by a lifter 5 with the help of a support frame 3. For receiving the turbine component 7 the support frame 3 has a from-fit interface. To receive the turbine component 7 the lifter 5 is brought to a defined position below the rail structure 1. For better positioning of the lifter 5 guide rails 6 can be used. The lifter 5 can only move along with horizontal displacement 28 which is controlled by the guide rails 6. The end point of the horizontal displacement can be defined by a stopper (not shown). Once the lifter 5 is moved to the right position on the ground the support frame 3 can be lifted up with a vertical displacement 29 to the turbine component 7 to receive the turbine component 7 with its form fit shape. Dedicated platforms and scaffolding can be erected around the support frame 3 in order to support and protect workers during assembly and disassembly of the turbine component 7. For better accessibility and safety a work platform 4 can also be attached to the lifter 5. If needed such a platform 4 facilitates manual securing of the turbine component 7 to the support frame 3 and manual releasing of the turbine component 7 from the traveller 10. For safety reasons a platform 4 typically has a railing (not shown).

Several rail structures 1 can be attached to the turbine 30 and remain attached such that no time is needed for attaching and removing them during an outage of the turbine.

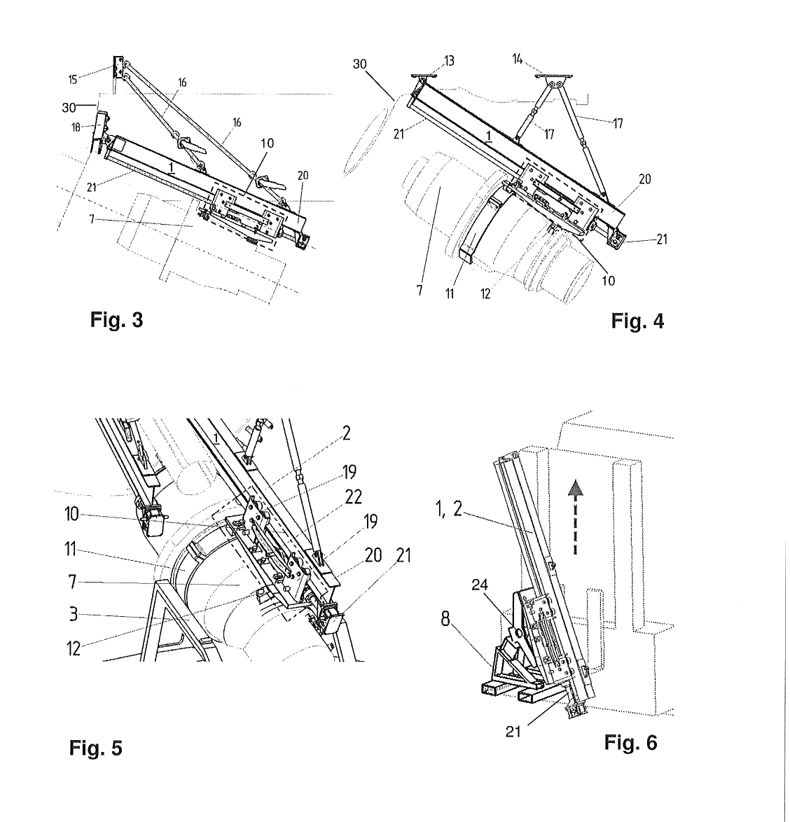

FIG. 3 shows an example of a side wall mounted rail structure 1 in more detail. The rail structure is attached to a side wall of the turbine 30 via brackets 15, 18. A beam 20 supporting the rail structure 1 is attached to a first bracket 18 via a pivotable joint. Two chains 16 span from a second bracket 15 attached to the wall of the turbine 30 above the first bracket 18 to the rail structure and hold the beam 20 in a defined angle relative to the turbine 30. The tilt angle of the beam 20 can be adjusted by adjusting the length of the chain 16, e.g. with the help of a chain block. The angle of the beam 20 relative to a horizontal plane is typically equal to the direction of the main axis of the turbine component 7, respectively axis of the opening in the turbine 30 for receiving the turbine component 7. When aligned to the axis of the opening the turbine component 7 can easily be mounted or dismounted by the traveller 10 which can move along the rail structure 1 with the tilt angle of the beam 20. The traveller 10 can be moved along the rail structure 1 with the help of a jack screw system 21.

FIG. 4 shows an example with an overhead mounted rail structure 1. The rail structure is attached to an overhead wall of the turbine 30 via brackets 13, 14. A beam 20 supporting the rail structure is attached to a first bracket 13 via a privotable joint. Two tie rods 17 span from a second bracket 14 attached to the wall of the turbine 30 to the rail structure and hold the beam 20 in a defined angle relative to the turbine 30. The tilt angle of the beam 20 can be adjusted by adjusting the length of the tie rods 17. The angle of the beam 20 relative to a horizontal plane is typically equal to the direction of the main axis of the turbine component 7, respectively axis of the opening in the turbine 30 for receiving the turbine component 7. The traveller 10 can be moved along the rail structure 1 with the help of a jack screw system 21.

FIG. 5 shows an example the rail structure 1 with a traveller 10 and holder for attaching the turbine component 7 to the traveller 10. In this example the holder comprises a form fit belt 11 which can be buckled on the turbine component 7 and a bracket 12 for mounting the turbine part to the traveller, e.g. with bolts. The traveller 10 comprises two trolleys 19 which are fastened to the beam 20 which is configured as a monorail 2. The traveller can be pushed and pulled along the rail 2 with the help of the jack screw system 21. Thus the traveller can move from a mounting/dismounting position where the turbine component 7 can be fixed, respectively released form the turbine to a position for loading, respectively unloading onto the lifter 5. The jack screw system 21 allows fine tuning of the traveller 10 position in the direction of the rail 2.

For removal of the turbine component 7 a horizontal adjustment screw 22 allows adjustment of the turbine component's 7 position in a direction normal to the longitudinal extension of the rail 2 for exact placement of the turbine component 7 on the support frame 3 which is lifted to receive the turbine component 7 by the lifter 5 (not shown in this Fig.).

For mounting of the turbine component 7 the horizontal adjustment screw 22 allows adjustment of the holder's 11, 12 position in a direction normal to the longitudinal extension of the rail 2 for exact placement of the holder 11, 12 attached to the traveller 10 after the turbine component 7 has been lifted on the support frame 3 by the lifter 5 (not shown in this Fig.) towards the traveller 10 such that the holder can be attached to the traveller 10.

FIG. 6 shows an example of a lifter 5 with a tool frame 8 holding a rail structure 1. For mounting the rail structure 1 to the turbine 30 the lifter 5 can be moved to a defined position on the ground. The lifter 5 can lift the tool frame 8 holding the rail structure 1 up to a position where the rail structure 1 can be connected to the turbine 30 (not shown). The rail structure 1 can be brought in the correct angle relative to the horizontal plane by pivoting it around a horizontal axis with the help of a worm-gearbox 24. Fine tuning of the position of the rail structure 1 relative to the turbine 30 can be done by moving the rail structure with the help of the jack screw system 21.

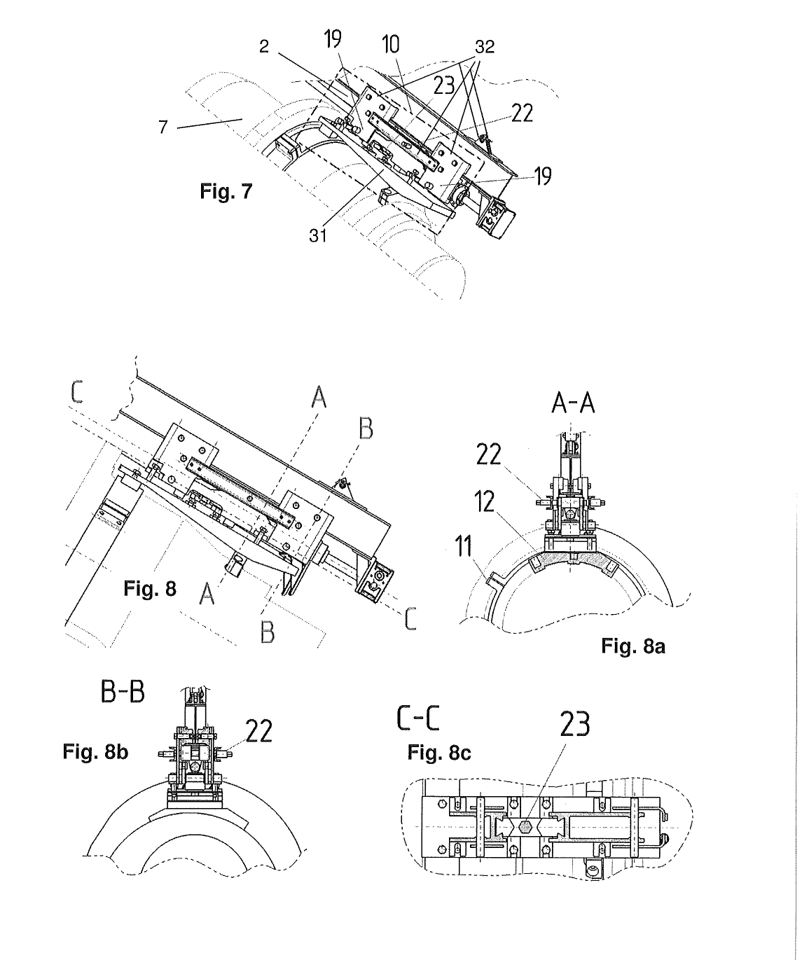

FIG. 7 shows an example of a traveller 10 in more detail. The traveller 10 comprises a first section 31 which is directly attached to the rail 2 via two trolleys 19. The position of the first section 31 can only be changed along rail 2. For adjustment of the travellers position in a plane normal to the longitudinal extension of the rail 2 the traveller comprises a second section 32 which is attached to the first section via a horizontal adjustment screw 22 and a vertical adjustment screw 23. Adjustment of normal to the longitudinal extension of the rail 2 can be advantageous for attaching the turbine component 7 to the traveller 10, for mounting the turbine component 7 to the turbine 30 or for placing it on the support frame 3, or also for placing the rails structure on the tool frame 8.

FIG. 8, 8a, 8b, 8c shows details of a traveller 10 with cross sections A-A, B-B and C-C indicated in FIG. 8. FIG. 8a shows Cross section A-A with the horizontal adjustment screw 22 and the holder comprising of a belt 11 and a bracket 12. FIG. 8b shows Cross section B-B with the horizontal adjustment screw 22 and FIG. 8c shows the vertical adjustment screw 23 in Cross section C-C.

It will be appreciated by those skilled in the art that the present disclosure can be embodied in other specific forms without departing from the spirit or essential characteristics thereof. The presently disclosed embodiments are therefore considered in all respects to be illustrative and not restrictive.

The disclosed mounting system and method can for example be used for mounting a combustor or burner of a gas turbine into the casing of a gas turbine and for removal of a combustor or burner of a gas turbine from the casing of a gas turbine.

1. A mounting system for mounting and/or removing a turbine component from a turbine, the mounting system comprising a suspended rail structure for moving the turbine component with a traveller which can move along a rail of the rail structure and can be connected to a holder for attaching the turbine component to the traveller, and a lifter with a support frame which is attachable to the lifter and configured for receiving the turbine component with the holder.

2. The mounting system according to claim 1, further comprising a guide rail for guiding the lifter along a predefined path.

3. The mounting system according to claim 1, wherein the holder comprises a belt which is form fit to a first section of the turbine component.

4. The mounting system according to claim 1, wherein the holder comprises a bracket which is configured for connection to a second section of the turbine component.

5. The mounting system according to claim 1, wherein the suspended rail structure comprises a beam, and in that the traveller comprises a trolley and/or a linear guide connected to the rail.

6. The mounting system according to claim 1, further comprising a jacking screw system for pushing and pulling the traveller along the rail.

7. The mounting system according to claim 6, wherein the jacking screw system is a self-breaking system.

8. The mounting system according to claim 1, further comprising a bracket connected to one end of the rail structure with a joint, and brackets for connected to the rail structure via a tie rod or a chain spanning from the brackets to the rail structure for a hinged suspension.

9. The mounting system according to claim 8, wherein the joint connecting the end of the rail structure to the bracket allows an adjustment of the tilt angle of the rail structure by adjusting the length of the tie rod or the chain.

10. The mounting system according to claim 1, wherein the traveller comprises a first section for movable connection to the rail structure, a second section for connection to the holder, an interface connecting the first section to the second section, wherein the interface is configured for adjusting the position of the second section relative to the first section for aligning the position of the turbine component suspended by the mounting system relative to the turbine.

11. The mounting system according to claim 1, further comprising a tool frame attachable to the lifter and configured for receiving the rail structure with the traveller for mounting/dismounting the rail structure with the traveller to a turbine.

12. The mounting system according to claim 1, further comprising at least one of a manual handle, an electro motor, and a pneumatic motor for moving the traveller relative to the rail structure.

13. A method for removing a turbine component from a turbine comprising:
providing a mounting system for mounting and/or removing a turbine component from a turbine, the mounting system comprising a suspended rail structure for moving the turbine component with a traveller which can move along a rail of the rail structure and can be connected to a holder for attaching the turbine component to the traveller, and a lifter with a support frame which is attachable to the lifter and configured for receiving the turbine component with the holder,
mounting the rail structure with the traveller to the turbine with a tie rod and/or a chain,
aligning the rail structure with the turbine component by adjusting the length of the tie rod or chain,
which is connecting the rail structure to the turbine,
attaching the turbine component to the traveller,
pulling the turbine component out of the turbine by moving the traveller along the rail structure,
moving the lifter with the support frame attached to it to a defined position below the turbine component,
lifting the support frame up to receive the turbine component,
detaching the turbine component from the traveler, and
removing the turbine component with the lifter which is holding the support frame and turbine component.

14. The method for removing a turbine component from a turbine, wherein the mounting the rail structure with the traveller to the turbine with the tie rod or the chain comprises the steps of attaching tool frame to the lifter, and attaching the rail structure with the traveller to tool frame, moving the lifter to a defined position next to or below the turbine and lifting the rail structure with the traveller for mounting to the turbine with the lifter.

15. A method for mounting of a turbine component, the method comprising:
providing a mounting system for mounting and/or removing a turbine component from a turbine, the mounting system comprising a suspended rail structure for moving the turbine component with a traveller which can move along a rail of the rail structure and can be connected to a holder for attaching the turbine component to the traveller, and a lifter with a support frame which is attachable to the lifter and configured for receiving the turbine component with the holder,
mounting the rail structure with the traveller to the turbine with a tie rod or a chain,
aligning the rail structure with the turbine component by adjusting the length of the tie rod or chain, which is connecting the rail structure to the turbine,
moving the turbine component with the lifter which is holding the support frame and turbine component to a defined position below the rail structure,
lifting the support frame with the turbine component up to the traveller, connecting the turbine component to the traveller,
lowering the support frame with the lifter,
pushing the turbine component into the turbine by moving the traveller along the rail structure, and
detaching the turbine component from the traveller.
